(19) United States
(12) Patent Application Publication
(10) Pub. No.: US 2016/0083286 A1
(43) Pub. Date: Mar. 24, 2016

(54) BLANK MOLD AND NECK MOLD HAVING REDUCED RELATIVE FRICTION

(71) Applicant: SAINT-GOBAIN EMBALLAGE, Courbevoie (FR)

(72) Inventor: Cyril ESCURE, Saint-Remy (FR)

(21) Appl. No.: 14/890,778

(22) PCT Filed: May 7, 2014
(86) PCT No.: PCT/FR2014/051065

§ 371 Date: Nov. 12, 2015

(30) Foreign Application Priority Data
May 13, 2013 (FR) 1354253
Dec. 6, 2013 (FR) 1362222

(51) Int. Cl. C03B 40/02; C03B 9/48

(52) U.S. Cl. CPC C03B 40/02; C03B 9/48

(57) ABSTRACT

An assembly includes a blank mold and a neck mold which are intended to cooperate for the forming of a blank with a view to the production of a hollow glass article, wherein a surface of the blank mold and a surface of the neck mold that rub against one another have a composition that reduces the friction between the two molds, and the wear thereof. The composition includes a nickel-based alloy and/or a cobalt-based alloy.

The present invention relates to the industrial manufacture of hollow glass articles such as bottles, pots, flasks, etc.

Hollow glass articles are manufactured in two steps:
the production of a blank;
the conversion of this blank into a finished product (bottle, pot, flask, etc.).

The blank production step is carried out with the aid of various molding components, in particular a blank mold and a neck mold.

At the end of the blank production step, during the opening of the blank mold which releases the blank held by the neck mold, frictions occur between the blank and the neck mold. These frictions may indirectly give rise to defects on the articles produced. These defects, of “neck check” type render the article unsuitable and the latter is rejected, leading to yield losses.

To date, in order to limit the friction between the blank mold and the neck mold, use is made of a “grease” (mixture of hydrocarbons, graphite and sulfur usually). On producing the blank, the neck mold is positioned beneath the blank mold, which has a concave surface referred to as an enclosure and that constitutes a jaw with respect to the corresponding convex peripheral surface of the neck mold. The auxiliary means associated with the neck mold via the underside, in particular the plunger block comprising the plunger and the barrel (used to pierce the neck of the blank and to thus trigger the formation of the cavity therein) apply an upward pressure to the neck mold pushing it against the blank mold. It is a portion of the upper surface of the neck mold, generally a portion relatively far from the axis of the blank, which is subjected to friction with the blank mold upon the opening of the latter.

The portion of this upper surface of the neck mold closest to the axis of the blank has a sharp edge at a distance of a few hundredths of a millimeter, of the order of four hundredths of a millimeter for example, opposite and below a sharp edge presented by the lower surface of the blank mold. This sharp edge of the blank mold also constitutes the portion of its lower surface closest to the axis of the blank. In other words, these sharp edges, which do not touch in theory—even though this may occur in certain circumstances—are intended to come into contact with the molten glass. They may consist of a nickel-based alloy. The objective of the provision of this alloy is in this case a mechanical strengthening of the sharp edge in order to improve its impact strength.

These are therefore the portions, relatively far from the axis of the blank, of the upper surface of the neck mold on the one hand and of the lower surface of the blank mold on the other hand, which rub against one another. In order to reduce this friction, the upper surface of the neck mold is smeared with grease; it is therefore understood that priority should above all be given, in this regard, to the most peripheral portion, furthest from the axis of the blank.

The use of grease poses many problems:
environment, health and safety: exposure of the operator who carries out the greasing operation to oil mists, to noise and to heat in the machine environment;
safety: exposure of the operator to the machine;
loss of efficiency: the manufacturing sections are shut down during the greasing operation; furthermore, the first bottles manufactured after greasing are scrapped;
articles marked by the grease.

The objective of the invention was to reduce the frequency of greasing of the neck molds, or even to eliminate it. The friction between the blank mold and the neck mold was able to be reduced, and also the wear thereof, to a degree such that the objective was able to be achieved.

For this purpose, one subject of the invention is an assembly comprising a blank mold and a neck mold which are intended to cooperate for the forming of a blank with a view to the production of a hollow glass article, characterized in that one surface of the blank mold and one surface of the neck mold that rub against one another have a composition that reduces the friction between the two molds, and the wear thereof, comprising:
a nickel-based alloy containing, in % by weight:
Cr: 0-25
C: 0.01-1
W: 0-30
Fe: 0-6
Si: 0-6
B: 0-5
Co: 0-10
Mn: 0-2
Mo: 0-35
Cu: 0-4
Nb: 0-5
Ta: 0-5
Ni: balance; and/or
a cobalt-based alloy containing, in % by weight:
Ni: 0-20
Cr: 0-35
C: 0-3
W: 0-15
Fe: 0-5
Si: 0-6
B: 0-5
Mn: 0-2
Mo: 0-35
Cu: 0-6
Co: balance.

According to other preferred features of the assembly according to the invention:
said one surface of the blank mold and one surface of the neck mold are substantially perpendicular to the axis of said blank, and relatively far from this axis;
said one surface of the blank mold and one surface of the neck mold comprise, at least in part, at least one of the following solid lubricants, or a mixture of several thereof:
   graphite,
   XF₂ where X is selected from Ca, Mg, Sr, Ba, in particular CaF₂, MgF₂ and BaF₂,
   XF₃ where X is selected from Sc, Y, La and rare earths,
   BN having a hexagonal structure,
   MoS₂ (molybdenite), WS₂ (tungstenite), CrS,
   X₂MoOS₃ where X is Co or Ni,
   MₐSi_{b} where M=Mo, W, Ni, or Cr, for example MoSi₂,
   XₐB_{b} where X is Mo, Cr, Co, Ni, Fe, Mn, V, Ti or Zr, in particular TiB₂, ZrB₂,
   XₐY_{b}B_{c} where X and Y are selected from Mo, Cr, Co, Ni, Fe, Mn, V, Ti and Zr, in particular MoCoB or Mo₂NiB₂,
   XSiB where X is Mo, Cr, Co, Ni, Fe, Mn, V, Ti or Zr;
said one surface of the blank mold and one surface of the neck mold comprise, at least in part, a first phase of nickel-based or cobalt-based alloy and a second phase consisting of a solid lubricant or a mixture of solid lubricants; the weight proportion is then advantageously 60%-100% for the first phase and 0%-40% for the second phase;
said one surface of the blank mold and one surface of the neck mold consist, at least in part, of a coating comprising a nickel-based alloy;
said one surface of the blank mold and one surface of the neck mold consist, at least in part, of a coating comprising a cobalt-based alloy;
said one surface of the blank mold and one surface of the neck mold comprise, at least in part, an inlay of solid lubricant.

Various deposition techniques are used within the context of the invention for forming the nickel-based or cobalt-based alloy coatings. Mention may be made of thermal flame spraying, thermal plasma spraying, HVOF (high velocity oxy-fuel) spraying, in particular carried out by means of devices under the Jet Kote® registered trademark, plasma transferred arc (PTA) spraying, and cold spraying.

The thickness of the nickel-based or cobalt-based alloy coatings is between 10 μm and 10 mm, for example between 30 and 500 μm by HVOF spraying, between 50 μm and 1 mm by thermal plasma spraying and up to 5 mm by PTA spraying.

Other subjects of the invention consist of:
an I.S. (individual section) machine, at least one section of which comprises at least one assembly as described above;
a process for manufacturing a hollow glass article using at least one assembly as described above.

The invention is now illustrated by the following exemplary embodiment, described with reference to the appended drawings, in which:

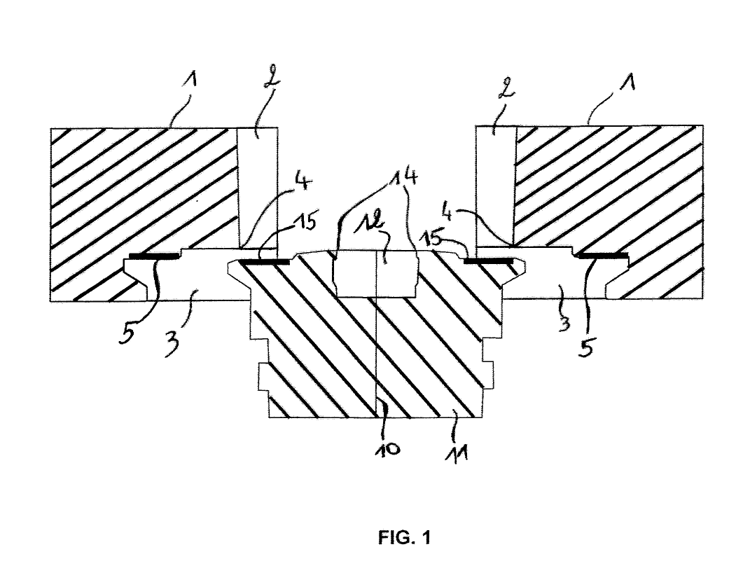

FIG. 1 is a cross-sectional partial schematic representation of a blank mold in the open position and of a corresponding neck mold, in accordance with the invention;

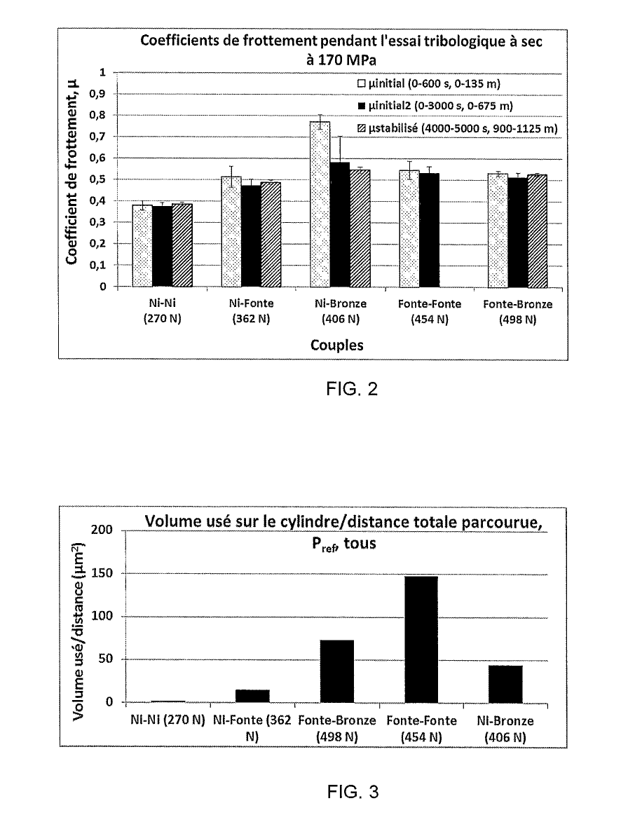

FIGS. 2 and 3 illustrate the friction coefficients and the worn volume for various pairs of friction surfaces, during a dry test;

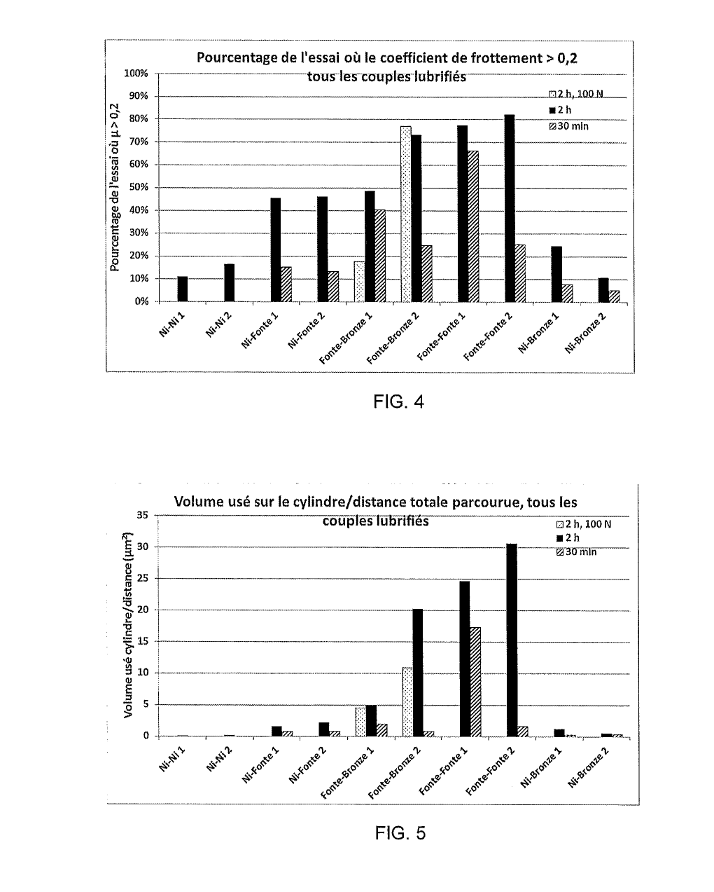

FIGS. 4 and 5 illustrate the friction coefficients and the worn volume for various pairs of friction surfaces, during a lubricated test.

With reference to FIG. 1, a blank mold 1 essentially consisting of cast iron is represented in the open position. Seen therein is the cavity 2 of the body of the blank, a concave inner surface 3 referred to as an enclosure 3 and intended for the nesting, holding and blocking of the neck mold 11, essentially consisting of cast iron or bronze. Seen from the latter is the parting line 10 and the neck cavity 12.

Also distinguished are the sharp edges 4 of the blank mold and 14 of the neck mold, intended for contact with the molten glass. The sharp edges 4, 14 frequently consist of a nickel-based alloy for the mechanical reinforcement thereof, in order to improve the impact strength thereof.

When the blank mold 1 is closed over the neck mold 11, before receiving a new molten glass parison, the tool associated with the neck mold 11, in particular the plunger block consisting of the plunger and the barrel, pushes the neck mold 11 upward, against the blank mold 1. The two molds are then touching at the peripheral upper surface of the enclosure 3, i.e. the surface furthest from the median vertical axis of the figure (axis of symmetry, axis of the blank). The sharp edges 4, 14 are almost touching, but are nevertheless 4 hundredths of a millimeter apart.

The contact surfaces 5, 15 of the two molds 1, 11 consist of a nickel-based alloy containing, in % by weight:
C: 0.3
B: 1.2
Si: 3.7
Fe: 3.0
Cr: 7.0
Ni: balance.

On opening the blank mold 1, the two molds 1, 11 are only in contact via their surfaces 5, 15. The nickel-based alloy of which these surfaces consist reduces their friction and their wear, making it possible to reduce the frequency of greasing of the neck mold, or even to eliminate it.

Tribological tests are carried out by reproducing the frictions of the blank mold with respect to the neck mold. The rubbing surface of the blank mold may consist of cast iron or a friction-reducing composition, represented here by the aforementioned nickel-based alloy. The rubbing surface of the neck mold may consist of the same materials plus bronze. Five pairs of blank mold-neck mold rubbing surfaces are studied: nickel-nickel, nickel-bronze, nickel-cast iron, cast iron-cast iron and cast iron-bronze.

The term “nickel” denotes here a “nickel-based alloy” as described above.

While the conventional definition of bronze is: alloy of copper (Cu) and tin (Sn), the term “bronze” denotes here a copper-nickel-aluminum alloy in the following proportions relating to the neck molds:
Ni: 10-16
Al: 7-10
Zn: 9-12
Fe: <1
Pb: <0.1
Sn: <0.1
Cu: balance.

In order to reproduce the friction of the blank mold and of the neck mold, the blank mold is replaced by a cylinder having a thickness of 15 mm, a diameter of 50 mm and having a round hole at the center with a diameter of 8 mm in order to attach the cylinder to a sample holder with a screw, and the neck mold is replaced by a pellet having a thickness of 5 mm and a diameter of 25 mm. The cylinders are made of cast iron or of cast iron coated with nickel-based alloy. The pellets are made of cast iron, of bronze or of cast iron coated with nickel-based alloy. For the coated samples, the thickness of the coating deposited by thermal spraying is from 1 to 2 mm. Although the blank mold-neck mold pair is replaced by a cylinder-pellet pair, the cylinder and the pellet may simulate either the blank mold or the neck mold.

Tests are carried out with a Cameron-Plint tribometer by applying a reciprocating movement of the cylinder against the pellet. The stroke length of the cylinder is 10 mm, the average translational speed of the cylinder is 225 mm/s, reproducing the opening speed of the blank molds. This speed corresponds to a maximum translational speed of the cylinder of 318.2 mm/s.

The assembly is maintained at a temperature of 360° C., which is approximately the minimum temperature observed on the upper face on the neck mold.

Dry tests and lubricated tests are carried out.

When lubrication is carried out, use is made of a lubricant sold by the Total group under the Kleenmold® 170 registered trademark, containing, in % by weight, 70%-80% of petroleum, 5%-6% of graphitic carbon, 4%-5% of sulfur and 20%-30% of additives.

The force applied varies between 100 and 500 N. Most of the tests used a reference pressure of 170 MPa which makes it possible to compare the results. FIGS. 2 and 3 present the results of the dry tests at the reference pressure of 170 MPa.

FIG. 2 presents the average friction coefficients for all the pairs of rubbing surfaces at the reference pressure of 170 MPa. This reference pressure corresponds to different applied forces depending on the pairs of rubbing surfaces, the forces being indicated on the graph of the figure. From the average friction coefficients, that of the Ni—Ni pair is still the lowest and the most favorable. For the Ni-bronze pair, the initial coefficient (between 0 and 600 s, 0 and 135 m of reciprocating translation of the cylinder) is the highest, then decreases. The friction coefficient of the other pairs does not change very much with time.

The graph in FIG. 3 gives the rate of wear on the cylinder. The cast iron-cast iron and cast iron-bronze tests give the greatest wear on the cylinder, and the Ni—Ni test the lowest wear.

The percentage of the test where the friction coefficient is greater than 0.2 for each lubricated test is presented in FIG. 4. Two lubricated tests at 100 N were carried out for the cast iron-bronze pair for which this force appeared to be relevant when dry. The other tests were carried out with a lubrication at a frequency simulating a greasing every two hours, respectively every 30 minutes, under industrial conditions, and at the reference pressure of 170 MPa.

For the Ni—Ni pair at the 30 min frequency, the friction coefficient rose higher than 0.2 very briefly for one test and never for the other. The values for Ni—Ni at the 2 h frequency are the lowest of all the tests. Despite its severe friction when dry, the lubricated friction coefficient for the Ni-bronze pair is the second lowest. For the cast iron-cast iron pair, the friction coefficient is greater than 0.2 for most of the duration of the test. Cast iron-bronze is the only other pair that saw tests where the friction coefficient is greater than 0.2 for more than half of the test.

The rate of wear on the cylinders for the lubricated tests is represented in FIG. 5. The rate of wear on the cylinder for the Ni—Ni pair is almost zero, while the cast iron-cast iron pair exhibits maximum wear. The wear is variable, according to the results for cast iron-bronze lubricated at the 2 h frequency, and for cast iron-cast iron lubricated at the 30 min frequency. The amount of grease remains an important factor. The reduction in the contact pressure appears to reduce the wear on the cylinder for the lubricated cast iron-bronze pair. The Ni-bronze pair has a relatively high rate of wear on the cylinder when dry, but when lubricated its rate of wear is lower than all the others, except that of the Ni—Ni pair.

In another test, a 100 μm thick coating of Tribaloy® T-400 is deposited on a cylinder, as described above, by HVOF spraying using a Jet Kote® device. The composition, in % by weight, of Tribaloy® T-400 is the following:
Ni: at most 1.5
Cr: 8.5
C: at most 0.08
Fe: at most 5
Si: 2.6
Mo: 29
Co: balance.

Use is made of a Cameron-Plint tribometer as explained above. The contact pressure with the pellet is constantly 170 MPa. Lubrication at a frequency simulating a greasing every two hours is carried out.

With respect to a nickel-based alloy pellet having a composition specified above in the example, the friction coefficient μ and the wear (worn volume of the cylinder/distance) are again slightly lower than for the Ni—Ni pair (FIG. 5), specifically constantly lower than 0.25 and lower than 0.04 μm², respectively.

1. An assembly comprising a blank mold and a neck mold which are intended to cooperate for forming a blank to produce a hollow glass article, wherein a surface of the blank mold and a surface of the neck mold that rub against one another have a composition that reduces the friction between the blank and neck molds, and the wear thereof, comprising:
a nickel-based alloy containing, in % by weight:
Cr: 0-25
C: 0.01-1
W: 0-30
Fe: 0-6
Si: 0-6
B: 0-5
Co: 0-10
Mn: 0-2
Mo: 0-35
Cu: 0-4
Nb: 0-5
Ta: 0-5
Ni: balance; or
a cobalt-based alloy containing, in % by weight:
Ni: 0-20
Cr: 0-35
C: 0-3
W: 0-15
Fe: 0-5
Si: 0-6
B: 0-5
Mn: 0-2
Mo: 0-35
Cu: 0-6
Co: balance,
or both said nickel-based alloy and said cobalt-based alloy.

2. The assembly as claimed in claim 1, wherein said surface of the blank mold and said surface of the neck mold are substantially perpendicular to an axis of said blank, and relatively far from said axis.

3. The assembly as claimed in claim 1, wherein said surface of the blank mold and said surface of the neck mold comprise, at least in part, at least one of the following solid lubricants, or a mixture of several thereof:
graphite,
XF₂ where X is selected from Ca, Mg, Sr, Ba,
XF₃ where X is selected from Sc, Y, La and rare earths,
BN having a hexagonal structure,
MoS₂ (molybdenite), WS₂ (tungstenite), CrS,
X₂MoOS₃ where X is Co or Ni,
MₐSi_{b} where M=Mo, W, Ni, or Cr,
XₐB_{b} where X is Mo, Cr, Co, Ni, Fe, Mn, V, Ti or Zr,
XₐY_{b}B_{c} where X and Y are selected from Mo, Cr, Co, Ni, Fe, Mn, V, Ti and Zr,
XSiB where X is Mo, Cr, Co, Ni, Fe, Mn, V, Ti or Zr.

4. The assembly as claimed in claim 1, wherein said surface of the blank mold and said surface of the neck mold comprise, at least in part, a first phase of nickel-based or cobalt-based alloy and a second phase consisting of a solid lubricant or a mixture of solid lubricants.

5. The assembly as claimed in claim 1, wherein said surface of the blank mold and said surface of the neck mold consist, at least in part, of a coating comprising a nickel-based alloy.

6. The assembly as claimed in claim 1, wherein said surface of the blank mold and said surface of the neck mold consist, at least in part, of a coating comprising a cobalt-based alloy.

7. The assembly as claimed in claim 1, wherein said surface of the blank mold and said surface of the neck mold comprise, at least in part, an inlay of solid lubricant.

8. An Individual Section machine, at least one section of which comprises at least one assembly as claimed in claim 1.

9. A process for manufacturing a hollow glass article using at least one assembly as claimed in claim 1.

10. The assembly as claimed in claim 3, wherein said at least one of the following solid lubricants, or a mixture of several thereof, includes at least one of CaF₂, MgF₂, BaF₂, MoSi₂, TiB₂, ZrB₂, MoCoB, and Mo₂NiB₂.
